(19) United States
(12) Patent Application Publication
(10) Pub. No.: US 2024/0095731 A1
(43) Pub. Date: Mar. 21, 2024

(54) BLOCKCHAIN DISTRIBUTION OF TOURNAMENT REWARDS

(71) Applicant: Community Gaming, Inc., New York, NY (US)

(72) Inventors: Christopher Gonsalves, New York, NY (US); Hayder Sharhan, Houston, TX (US); Ivan Solomichev, Austin, TX (US); Abdullah Furkan Ozbek, Istanbul (TR); Sangat Das, Maharashtra (IN)

(21) Appl. No.: 17/949,559

(22) Filed: Sep. 21, 2022

(51) Int. Cl. G06Q 20/38; G07F 17/32

(52) U.S. Cl. CPC G06Q 20/389; G06Q 20/3825; G07F 17/3258; G07F 17/3276; G06Q 2220/00

(57) ABSTRACT

A facility for blockchain distribution of competition rewards is described. The facility receives an indication of a competition including rules for the competition, and applies a smart contract to the competition that implements the rules for the competition. The facility receives an indication of one or more competitors who wish to participate in the competition and facilitates the creation of one or more cryptocurrency wallets for each of the competitors. For each competitor, the facility collects an entry fee and applies the cryptocurrency wallet to the generated smart contract such that the competitor is a party associated with the smart contract and the competition.

### BACKGROUND

Professional and amateur esports competitors increasingly participate and compete in esporting events and competitions (collectively “competitions”). Competitors are sometimes rewarded at the end of these events and competitions includes using computer systems that allocate prizes and facilitate various financial transactions involved in collecting entry fees and distributing rewards. Furthermore, submitting entry fees and receiving rewards sometimes involve using cryptocurrency and other virtual items (collectively “cryptocurrency”).

### BRIEF DESCRIPTION OF THE SEVERAL VIEWS OF THE DRAWINGS

FIG. 1 is a block diagram showing some of the components typically incorporated in at least some of the computer systems and other devices on which the facility operates.

FIG. 2 is a table diagram depicting a competitor information data table used by the facility in some embodiments.

FIG. 3 is a flow diagram of a process to generate one or more cryptocurrency wallets for a competitor, used by the facility in some embodiments.

FIG. 4 is a table diagram depicting a competition information data table used by the facility in some embodiments.

FIG. 5 is a flow diagram of a process to generate a smart contract for a competition, used by the facility in various embodiments.

FIG. 6 is a first tournament creation user interface presented by the facility in some embodiments.

FIG. 7A is a second tournament creation user interface presented by the facility in some embodiments.

FIG. 7B is an alternate second tournament creation user interface presented by the facility in some embodiments as part of creating a tournament.

FIG. 8 is a flow diagram of a process to determine the results of a competition based on the status of an instance of a game used by the facility in some embodiments.

FIG. 9 is a flow diagram of a process to distribute rewards to a competitor via a meta-transaction used by the facility in various embodiments.

### DETAILED DESCRIPTION

The inventors have recognized a variety of disadvantages of current methods to the management of cryptocurrency wallets and esports events and competitions. First, creating cryptocurrency wallets and ensuring that rewards and entry fees are collected from competitors requires technical proficiency in the use and creation of cryptocurrency wallets. This means competitors must spend time and effort learning how to create and manage these wallets in order to participate in many esports events and competitions. Additionally, the cost to submit and receive cryptocurrency is prohibitively high for the majority of competitors due to “gas fees” paid for the computing power required to adequately track the ownership of cryptocurrency. As a result of the large amount of computing overhead and fees rewards take a large amount of time to be distributed to competitors. The large amount of computing overhead and gas fees additionally made it difficult for competition organizers to create and competitions with cryptocurrency rewards.

Furthermore, competitors typically must manually keep track of the competition results. This results in the use of many “fail-safe” systems accurately track competition results, and in order to ensure that rewards are correctly distributed. These systems typically use the honor system, and when a competitor inaccurately reports results, additional computing power, time, and effort must be expended to verify or correct the reported results.

In response to recognizing these disadvantages, the inventors have conceived and reduced to practice a software and/or hardware facility for managing and creating cryptocurrency wallets and competitions.

The facility applies one or more smart contract to one or more competitions, such as individual events, tournaments, etc., in order to receive entry fees, distribute rewards, etc. The facility receives indication that an event organizer wishes to create a competition, such as via user input, and applies the smart contract based on the indication that the event organizer wishes to create the competition. In some embodiments, the indication that the event organizer wishes to create a competition includes one or more of: a type of video game used in the competition, competition rules, entry fees, rewards, reward distribution structure, and other information which may be used by the facility to cause a competition to be created. In some embodiments, the facility uses side chains, rollups, or other methods for scaling a blockchain network, to generate, or cause the generation of, the smart contract, aspects of the smart contract, etc. The facility uses the one or more smart contracts to perform one or more of: managing a tournament, including creating the tournament, enrolling competitors, deleting the tournament, removing competitors, or other aspects of creating or managing a tournament; manage contributions to reward pools for the tournament; validate the winners of the tournament; facilitate the payment of gas fees for cryptocurrency transactions generated, or caused to be generated, by the facility for the tournament; and disbursing the tournament prizes.

The facility uses the smart contract and a layer two blockchain network to cause cryptocurrency transactions to be generated or performed, such as receiving entry fees, distributing rewards, etc. In some embodiments, the facility automatically causes transactions between cryptocurrency wallets hosted on multiple blockchain networks, such as Polygon, Binance, or other blockchain networks, to be generated. In various embodiments, causing a transaction to be generated may include one or more of: generating the transaction, providing data regarding the transaction to a cryptocurrency transaction generation service or entity, or other methods of causing or facilitating the generation of a cryptocurrency transaction.

The facility receives an indication of one or more competitors which will participate in the competition, such as via user input. In various embodiments, a competitor is a single competitor or a group of competitors. In some embodiments, the indication of a competitor includes one or more of: an email address associated with the competitor, a name associated with the competitor, an identification number associated with the competitor, or other data used to identify a competitor.

The facility causes one or more cryptocurrency wallets to be created for a competitor based on the indication of the competitor. In some embodiments, the facility receives an indication of an existing cryptocurrency wallet associated with a competitor, such as via user input. In some embodiments, the facility facilitates the creation of a non-custodial wallet for the competitor. In some embodiments, the facility automatically transfers a created cryptocurrency wallet to an entity other than the entity associated with the facility, thereby allowing a competitor associated with the cryptocurrency wallet to manage the cryptocurrency wallet independently of the facility.

The facility determines which competitors received rewards based on the results of the competition and the smart contract. In some embodiments, the rewards include one or more of: cryptocurrency, non-fungible tokens (“NFTs”), virtual items or objects for use in a video game or other software, or other types of virtual items, objects, or currency. The facility places the rewards in a “reward pool” or “prize pool.” In some embodiments, at least a portion of the rewards in the reward pool are provided by competitors, such as in the form of entry fees for the competition. In some embodiments, at least a portion of the rewards in the reward pool are provided by a sponsor, such as one or more of: the tournament organizer, donations from one or more competitors or non-competitors, and an entity other than the organizer or competitors. In some embodiments, the competition organizer determines when the rewards are able to be claimed by the competitors. In some embodiments, the organizer cannot allow competitors to claim rewards until the results of the competition are finalized. In some embodiments, the facility transfers rewards from the reward pool into an “escrow pool” for at least one competitor when the results of the competition are finalized. In some embodiments, the escrow pool and reward pool are logical constructs, and transferring rewards from one to another is done without actually transferring the rewards to another entity or cryptocurrency wallet.

The facility causes the generation and execution of a cryptocurrency transaction based on the results of the competition and the smart contract to distribute the reward from the reward pool to the competitor, such as to the competitors cryptocurrency wallet, to an escrow pool, etc. In some embodiments, the facility distributes the reward to the competitor in response to an indication that the competitor would like to claim the reward. In some embodiments, where the escrow pool includes multiple rewards earned by a competitor, the facility causes the generation of a cryptocurrency transaction which enables competitors to receive a plurality of their rewards at once. In some embodiments, the facility receives an indication of a second cryptocurrency wallet associated with the competitor and causes the generation of a cryptocurrency transaction from the reward pool directly to the second cryptocurrency wallet. In such embodiments, transferring the reward directly to the second cryptocurrency wallet rather than forcing the user to transfer the reward manually results in less computing power and time required to transfer the reward from the reward pool to the first wallet, and from the first wallet to the second wallet.

By performing in some or all of the ways described above, the facility automates the creation of cryptocurrency wallets for esports competitors and management of the distribution of competition rewards to cryptocurrency wallets in a way that is quicker, fairer, and cheaper because of the blockchain techniques employed by the facility. For example, by using layer two networks and meta-transactions, such as those used on the Ethereum blockchain, the facility is able to significantly reduce gas fees and the time and computing power necessary to manage entry fees and distribute rewards. The facility additionally allows a user with little to no technical proficiency to automatically create and fund a cryptocurrency wallet. Furthermore, the facility ensures that competition results are accurate and competition rewards are quickly and accurately distributed to competitors.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by using meta-transactions and layer two networks, the facility vastly reduces the computing power and resources necessary to receive cryptocurrency entry fees and distribute cryptocurrency rewards for competitions. Additionally, by using reward pools and escrow pools, the facility is able to reduce the total number of cryptocurrency transactions needed to distribute rewards from multiple competitions to competitors, thus reducing the processing power and fees required to generate and execute the cryptocurrency transactions.

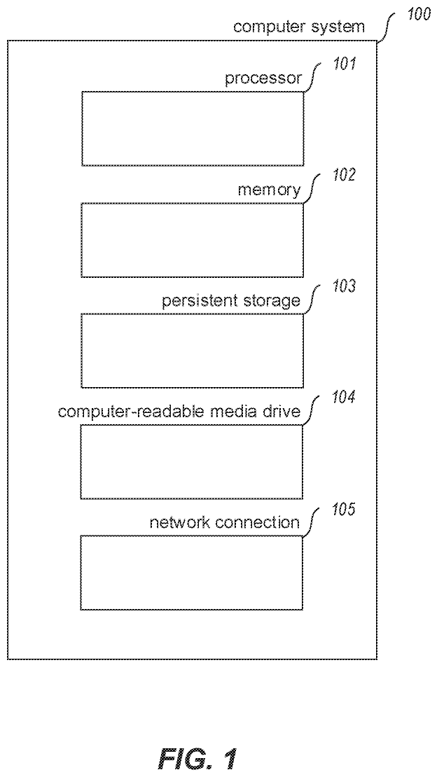

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or generating or implementing smart contracts, such as a CPU, GPU, TPU, NNP, Neural Network Accelerator, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

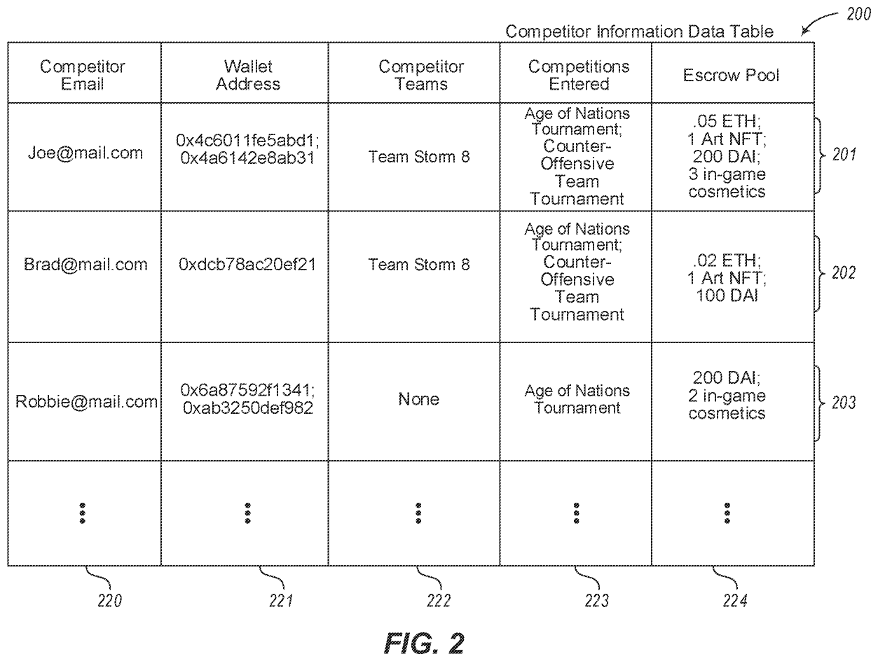

FIG. 2 is a table diagram depicting a competitor information data table 200 used by the facility in some embodiments to store data describing one or more competitors. Each row of the competitor information data table 200, such as rows 201-203, represents a competitor which is able to enter one or more competitions and obtain prizes or rewards from participating in the competitions. The facility populates the competitor information data table 200 by receiving or generating competitor information, such as via user input, generating cryptocurrency wallets, allocating rewards based on the performance of a competitor in a competition, or other sources of competitor information or data. Each row is divided into a competitor email column 220, a wallet address column 221, a competitor team column 222, a competitions entered column 223, and an escrow pool column 224. The competitor email column 220 includes information specifying an email for a competitor. The wallet address column 221 includes information specifying one or more cryptocurrency wallets for a competitor. The competitor team column 223 includes information specifying one or more teams with which the competitor is associated. The competitions entered column 223 includes information specifying one or more competitions which the competitor has entered. The escrow pool column 224 includes information specifying the rewards earned by the competitor.

For example, row 201 indicates that a competitor identified by the email address “Joe@mail.com” is associated with two cryptocurrency wallets, is a part of “Team Storm 8,” has entered two competitions, and has a variety of rewards in their escrow pool. Likewise, row 203 indicates that the competitor with email address “Robbie@mail.com” is associated with two cryptocurrency wallets, is not part of a team, is entered in one competition, and has few rewards in their escrow pool.

While FIG. 2 and each of the table diagrams discussed below show a table whose contents are designed to make them more comprehensible to a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

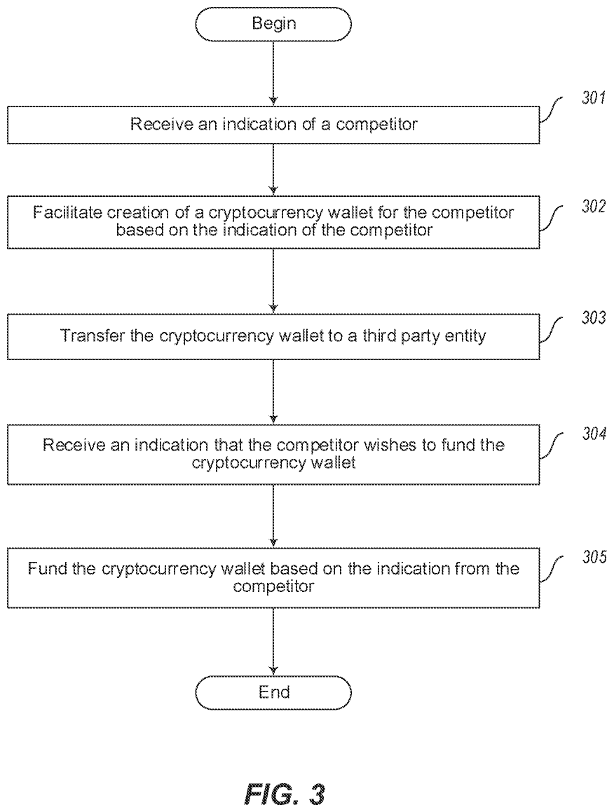

FIG. 3 is a flow diagram of a process performed by the facility in some embodiments to generate one or more cryptocurrency wallets for a competitor. First, at act 301, the facility receives an indication of a competitor. In some embodiments, the facility receives the indication of a competitor via user input, such as user input received via a website, smartphone application, or other visual user interface. In some embodiments, the indication of a competitor includes one or more of: an email address, a legal name of the competitor, a username of the competitor, an identification number associated with a competitor, or other information used to identify a competitor.

At act 302, the facility facilitates the creation of a cryptocurrency wallet for the competitor based on the indication of the competitor. In some embodiments, the facility facilitates the creation of the cryptocurrency wallet by applying the indication of the competitor to software configured to generate a cryptocurrency wallet, such as Magic Link. In some embodiments, the created cryptocurrency wallet is a non-custodial or self-managed wallet. At act 303, the facility transfers the cryptocurrency wallet to a third party entity.

At act 304, the facility receives an indication that the competitor wishes to fund the cryptocurrency wallet, such as via user input. In some embodiments, the indication that the competitor wishes to fund the cryptocurrency wallet includes information indicating one or more of: a credit card, a bank account, another cryptocurrency wallet, or other sources which can be used to fund a cryptocurrency wallet.

At act 305, the facility funds the cryptocurrency wallet based on the indication from the competitor. In some embodiments, the facility uses the Ramp Network to fund the cryptocurrency wallet. In some embodiments, the cryptocurrency wallet can be funded with one or more of: Bitcoin, Ethereum, USD Coin, NFTs, virtual items obtainable in a video game, or other cryptocurrency, tokens, or virtual items.

After act 305, the process ends. In some embodiments (not shown), instead of facilitating the creation of a wallet in act 302, the facility receives identifying information for an existing wallet owned by the competitor, such as a meta mask wallet.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

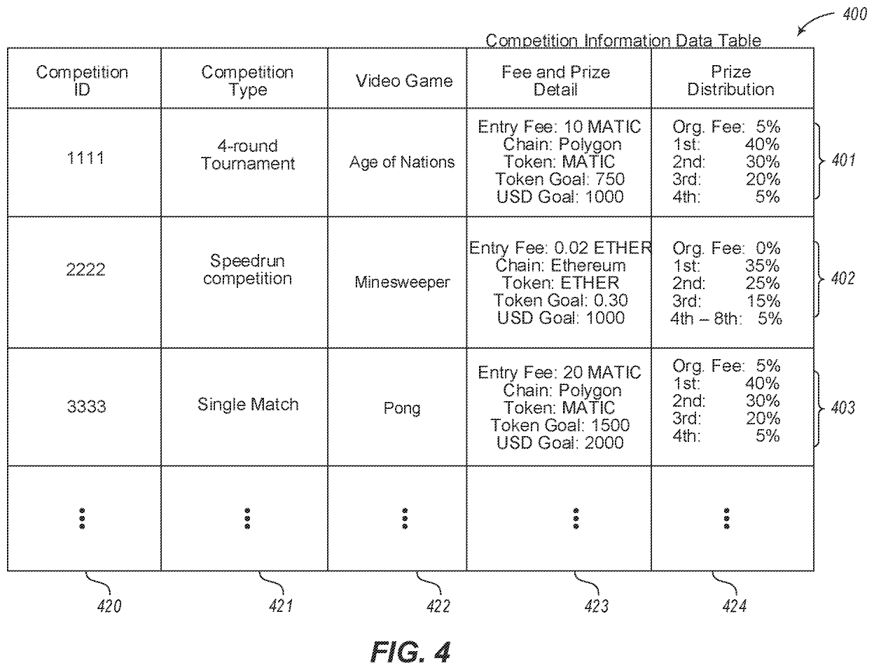

FIG. 4 is a table diagram depicting a competition information data table 400 used by the facility in some embodiments to store data describing one or more competitions. Each row of the competition information data table 400, such as rows 401-403, represents a competition created based on competition information received from an event organizer. The facility populates the competition information data table 400 by receiving or generating competition information, such as via user input, from one or more cryptocurrency exchanges, from one or more video game instances, or other sources of competition information or data. Each row is divided into a competition ID column 420, a competition type column 421, a video game column 422, a fee and prize detail column 423, and a prize distribution column 424. The competition ID column 420 includes information identifying a competition. The competition type column 421 includes information specifying the type of the competition. The video game column 422 includes information specifying a video game within which at least one round of the competition occurs. The fee and prize detail column 423 includes information specifying entry fees, prizes, prize types, and prize goals for the competition. The prize distribution column 424 includes information specifying the distribution of prizes to competitor escrow pools.

For example, row 401 indicates that competition “1111” is a four round tournament which is played in the game “Age of Nations.” Furthermore, competition “1111” has an entry fee of 10 MATIC, uses the “Polygon” blockchain and “MATIC” token, has a token goal of 750 MATIC, and has a U.S. dollar goal of $1000. The prizes for competition 1111 include an organizer fee of five percent of the prize pool, a first prize of forty percent of the prize pool, etc.

In some embodiments, the data table is stored as an array of tournaments inside of a smart contract, such as a smart contract configured to managing a tournament, including creating the tournament, enrolling competitors, deleting the tournament, removing competitors, or other aspects of creating or managing a tournament.

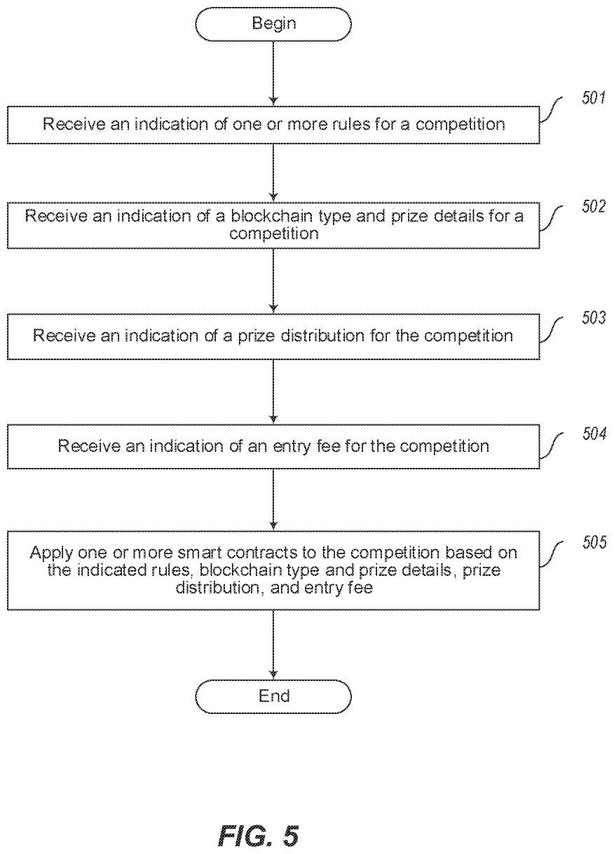

FIG. 5 is a flow diagram of a process performed by the facility in some embodiments to apply one or more smart contracts to a competition. First, at act 501, the facility receives an indication of one or more rules for a competition. In some embodiments, the facility receives the indicated rules from an event organizer, such as via user input received via a website, smartphone application, or other visual user interface. In some embodiments, the rules for the competition include one or more of: a type or format of the competition, one or more video games for the competition, one or more win-conditions for the competition, one or more rules for reporting the results of the competition or of rounds of the competition, and other rules regarding the management of a competition.

At act 502, the facility receives an indication of a blockchain type and prize details for a competition, such as via user input. The indicated blockchain type indicates one or more layer two blockchain networks, such as Polygon, Binance, or other blockchain networks. In some embodiments, the layer two blockchain network uses at least one of: side chains, rollups, or another blockchain network scaling solution. In some embodiments, the layer two blockchain network is proof of stake blockchain network. In some embodiments, where the facility receives multiple blockchain types, the facility monitors each blockchain to determine whether a transaction for the competition has occurred on each blockchain.

In some embodiments, the prize details include an indication of the prize for the competition, which includes at least one of cryptocurrency or other virtual items. In some embodiments, the prize detail includes a cryptocurrency goal or fiat currency goal (collectively a “prize goal”) for the prize pool. In such embodiments, the facility adjusts the amount of cryptocurrency or fiat currency awarded to competitors based on the goal. For example, an event organizer may set a prize goal of 750 MATIC and $1000 U.S. dollars, and indicates that the MATIC goal should be adjusted to match the U.S. dollar goal. The facility tracks the value of MATIC in U.S. dollars and changes the prize based on the change in the value of MATIC to ensure that the $1000 prize goal is met. In some embodiments, the facility adjusts the entry fee in a similar manner as adjusting the prize goal. In some embodiments, once the tournament is open for entry, the facility prevents the prizes and entry fees from changing. In some embodiments, the facility prevents competitors from entering the competition until the prize goal for the prize pool is met. In some embodiments, the prize pool is funded via one or more of: receiving entry fees, donations from other users or competitors to the prize pool, and cryptocurrency or virtual items provided by the event organizer when creating the competition.

At act 503, the facility receives an indication of a prize distribution for the competition, such as via user input. In some embodiments, the prize distribution includes an organizer fee which is awarded to a cryptocurrency wallet associated with an event organizer.

At act 504, the facility receives an indication of an entry fee for the competition. In some embodiments, the blockchain type and token for the entry fee is the same as the blockchain type and token for the prize. In some embodiments, the blockchain type and token for the entry fee is different than the blockchain type and token for the prize. In some embodiments, when the competition is a team-based competition, the entry fee may be split between members of a team which enters the competition.

At act 505, the facility applies one or more smart contracts to the competition based on the indicated rules, the blockchain type and prize details, prize distribution, and entry fee. In some embodiments, after the facility receives an entry fee from a cryptocurrency wallet associated with a competitor the facility updates the smart contract to based on the cryptocurrency wallet, such that the competitor becomes a party associated with the smart contract.

After act 505, the process ends. In some embodiments, the facility uses a first tournament creation user interface or a second tournament creation user interface to perform one or more of acts 501-504.

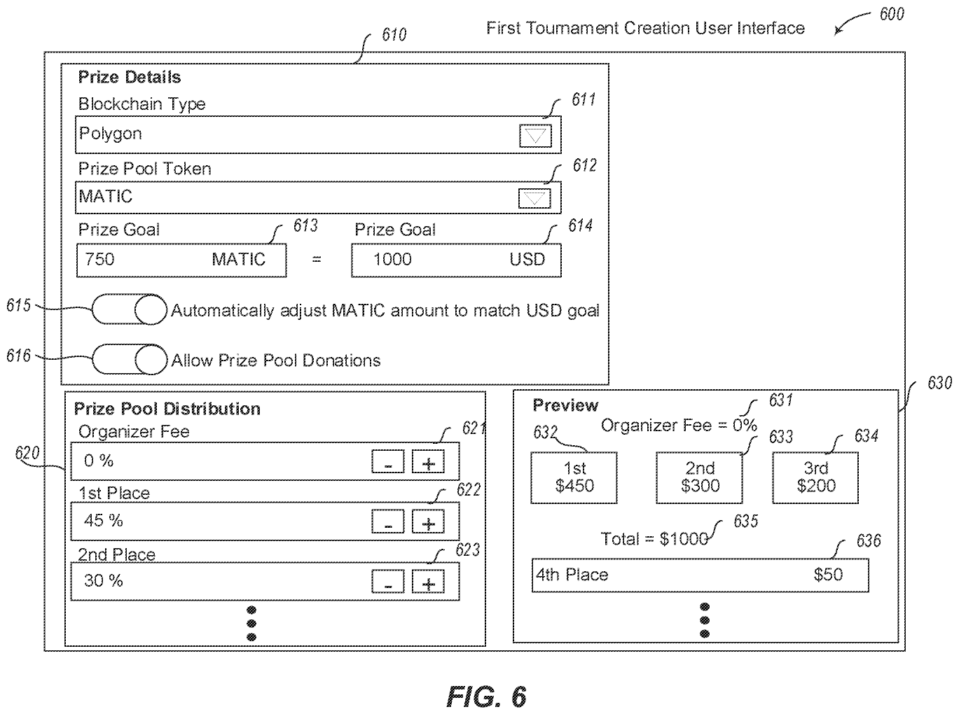

FIG. 6 is a first tournament creation user interface 600 presented by the facility in some embodiments as part of creating a tournament. The first tournament creation user interface 600 includes a prize detail section 610, a prize pool distribution section 620, and a preview section 630.

The prize detail section includes a blockchain type selector 611, a prize pool token selector 612, a token prize goal 613, a fiat prize goal 614, a goal adjustment checkbox 615, and a prize pool donations checkbox 616. The blockchain type selector 611 allows a user to indicate a blockchain type for the prize. The prize pool token selector 612 allows a user to indicate a token on the blockchain for the prize. The token prize goal 613 allows a user to indicate a token prize goal for the competition. The fiat prize goal 614 allows a user to indicate a fiat currency prize goal for the competition. The goal adjustment checkbox 615 allows a user to indicate that the facility should adjust the token prize goal to match the fiat prize goal. The prize pool donations checkbox 616 allows a user to indicate to the facility that a competitor may donate cryptocurrency to the prize pool without entering the competition.

The prize pool distribution section 620 includes an organizer fee selector 621, a first place selector 622, and a second place selector 623. As indicated by the vertical ellipses, prize pool distribution selection 620 may include additional selectors (not shown). The organizer fee selector 621 allows a user to indicate the amount of the prize pool which is awarded to the organizer of the competition. The first place selector 622 and second place selector 623 allow a user to indicate the amount of the prize pool which is awarded as the first place prize and second place prize respectively. In some embodiments, each of the selectors allow a user to specify a percentage of the prize pool which is awarded to the competitors. In some embodiments, each of the selectors allow a user to indicate a specific amount of the cryptocurrency or other virtual items included in the prize pool which is to be awarded to the competitors.

The preview section 630 includes an organizer fee 631, a first place award 632, a second place award 633, a third place award 634, a total award 635, and a fourth place award 636. As indicated by the ellipses, the preview section 630 may include additional rewards (not shown). The organizer fee 631 indicates the current organizer fee to a user. The first place award 632, second place award 633, third place award 634, and fourth place award 636 indicate the first, second, third, and fourth place award to the user based on the prize pool distribution and the prize goal. The total award 635 indicate the total award which can be awarded to users.

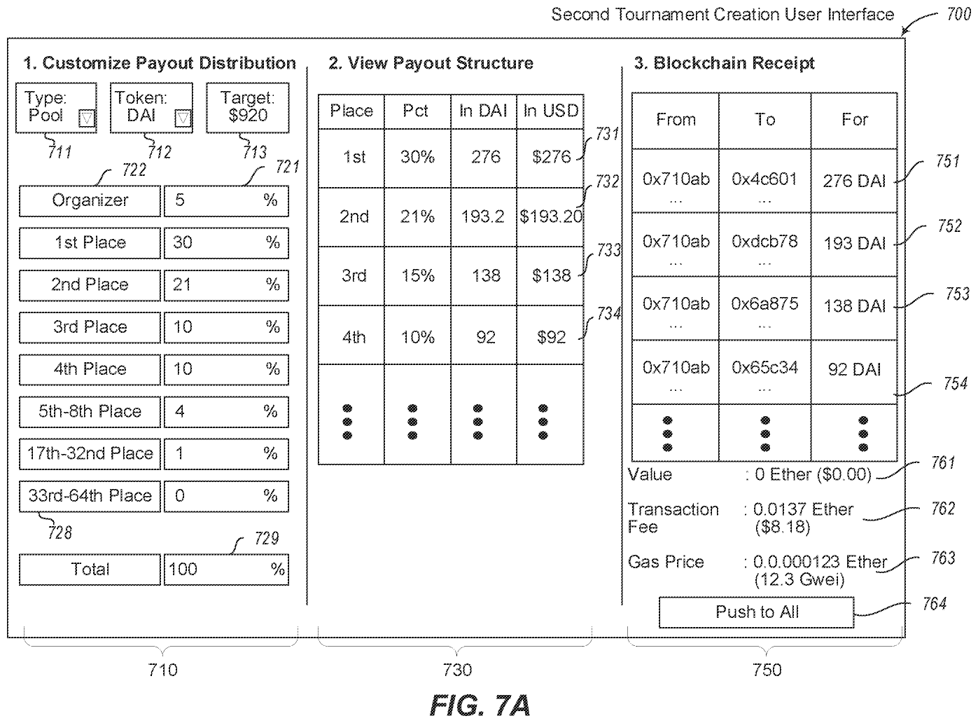

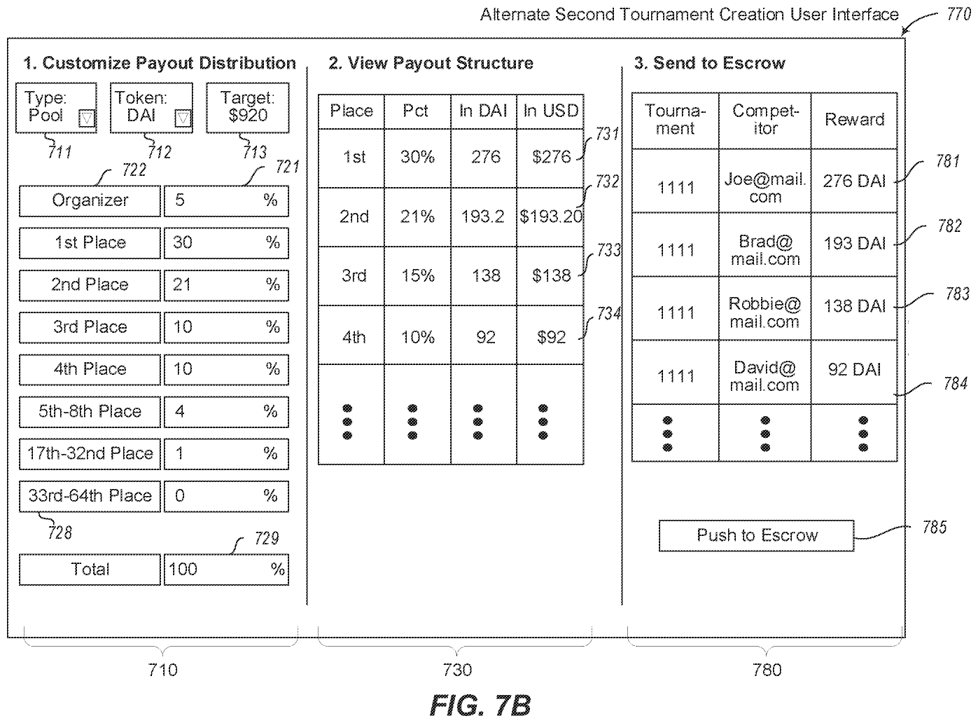

FIG. 7A is a second tournament creation user interface 700 presented by the facility in some embodiments as part of creating a tournament. The second tournament creation user interface 700 includes a payout distribution section 710, a payout structure section 730, and a blockchain receipt section 750.

The payout distribution section 710 includes a tournament type selector 711, a token selector 712, a target selector 713, one or more prize distribution selectors 721, and a prize pool award indicator 729. The tournament type selector 711 allows a user to indicate the type of funding received for the competition, such as: a prize pool, where competitors and other users pay into a prize pool which is distributed to competitors at the end of the competition; a sponsored competition, where an event organizer, or an entity other than the event organizer and competitors, provide the prize for the competition; or other methods of funding a prize for a competition. The token selector 712 allows a user to indicate the type of cryptocurrency or virtual item which is awarded to competitors. The target selector 713 allows a user to indicate a target, or goal, for the prize pool. The prize distribution selector 721 allows a user to indicate the amount of the prize pool which is awarded to a competitor or event organizer. For example, in the second tournament creation user interface 700, the organizer 722 is awarded five percent of the total prize pool, whereas the thirty-third to sixty-fourth place competitors 728 are awarded none of the total prize pool. The prize pool award indicator 729 indicates the total amount of the prize pool currently allocated to the organizer and each of the competitors.

The payout structure section 730 includes a table which indicates the prize payout structure for the distribution indicated in the payout distribution section 710. As indicated by row 731, the first place prize receives thirty percent of the prize pool which is equivalent to 276 DAI. Additionally, as indicated in row 731, 276 DAI is equivalent to $276 U.S. dollars. Likewise, rows 732-734 each indicate the distribution for second, third, and fourth place respectively.

The blockchain receipt section 750 includes a table which indicates the blockchain transactions associated with the competition, as well as the total fees which have been incurred as a result of the blockchain transactions associated with the competition. As indicated by row 751, the facility caused the generation and execution of a cryptocurrency transaction from a first cryptocurrency wallet to a second cryptocurrency wallet for 276 DAI, which corresponds to the first place prize indicated in row 731 in the payout structure section 730. Likewise, rows 752-754 indicate that the facility caused the generation and execution of cryptocurrency transactions corresponding to the second, third, and fourth place prizes indicated in rows 732-734 respectively. The value 761 indicates the amount of Ethereum transferred as a reward. The transaction fee section 762 indicates the total number of transaction fees incurred to receive entry fees, prize pool contributions, and distribute rewards for the competition. The gas price section 763 indicates the current prize to execute transactions on the blockchain used for the competition. The push to all button 764 initiates the cryptocurrency transaction to distribute the rewards from the reward pool directly to a cryptocurrency wallet associated with each of the competitors who earned a reward through participation in the tournament.

FIG. 7B is an alternate second tournament creation user interface 770 presented by the facility in some embodiments as part of creating a tournament. The second tournament creation user interface 770 includes a payout distribution section 710, a payout structure section 730, and a send to escrow section 780. The payout distribution section 710 is similar to the payout distribution section 710 of the second tournament creation user interface 700. The payout structure section 730 is similar to the payout structure section 730 of the second tournament creation user interface 700.

The send to escrow section 780 includes a table which indicates the competitors to which the competition rewards are to be awarded and a button to push the rewards to competitor escrow pools. As indicated by row 781, competitor “joe@mail.com” received a reward of “276 DAP” from tournament “1111.” Likewise, rows 782-784 indicate that other competitors received rewards from tournament “1111” as well. When an organizer activates the push to escrow button 785, the facility determines whether the competition has concluded, and pushes the rewards to each competitor's respective escrow pool.

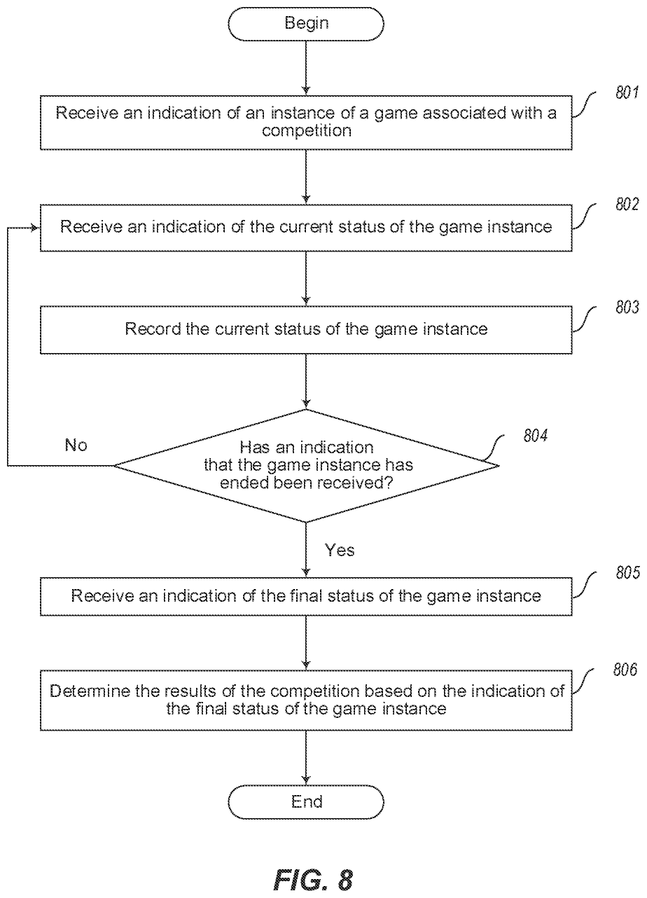

FIG. 8 is a flow diagram of a process performed by the facility in some embodiments to determine the results of a competition based on the status of an instance of a game. First, at act 801, the facility receives an indication of an instance of a game associated with a competition, such as via user input. In some embodiments, the event organizer provides the indication of the instance of the game to the facility.

At act 802, the facility receives an indication of the current status of the game instance. In some embodiments, the facility receives the indication of the current status of the game instance from one or more of: a competitor interacting with the game instance, the event organizer, and an oracle configured to obtain the status of the game instance. An “oracle” is a data source other than the competitors, organizers, and facility which tracks the results of a competition. In some embodiments, the oracle may use software which is included in, or has access to, data generated by one or more video games, game instances, etc., used in the competition.

At act 803, the facility records the current status of the game instance. At act 804, the facility determines whether an indication that the game instance has ended was received. In some embodiments, current status of the game instance includes an indication that the game instance has ended. If the indication that the game instance has ended has not been received, the facility returns to act 802, otherwise the facility proceeds to act 805.

At act 805, the facility receives an indication of the final status of the game. The facility performs act 805 in a similar manner to act 802.

At act 806, the facility determines the results of the competition based on the indication of the final status of the game instance. In some embodiments, the facility verifies the results of the competition based on the recorded statuses of the game instance. In some embodiments, the facility distributes the prize for the competition after receiving an indication from the event organizer that the results of the competition are correct.

In some embodiments, as part of act 806, the facility distributes the prize for the competition to one or more escrow pools for competitors which participated in the competition based on the determined result of the competition and the smart contract. In some embodiments, the facility distributes the prize to an existing escrow pool associated with the competitor.

In some embodiments, at act 806, where competitors in the competition include teams, the facility distributes the prize for the competition based on the teams of the competitors in the competition. In some embodiments, the facility distributes at least a portion of the prize to an escrow pool for one or more team members which did not participate in the competition.

After act 806, the process ends.

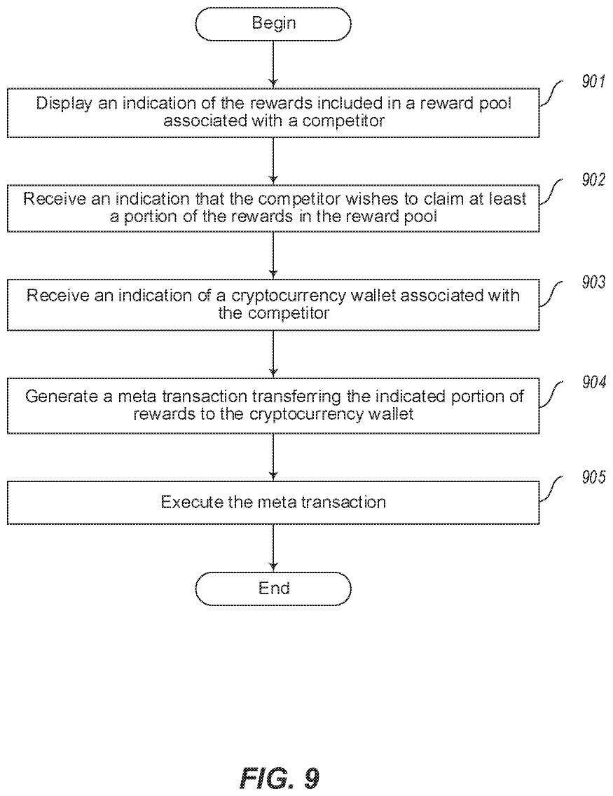

FIG. 9 is a flow diagram of a process performed by the facility in some embodiments to distribute rewards to a competitor via a meta-transaction. First, at act 901, the facility displays an indication of the rewards included in an escrow pool associated with a competitor.

At act 902, the facility receives an indication that the competitor wishes to claim at least a portion of the rewards in the escrow pool, such as via user input. At act 903, the facility receives an indication of a cryptocurrency wallet associated with the competitor. In some embodiments, the cryptocurrency wallet is the cryptocurrency wallet the competitor used to pay an entry fee for a competition. In some embodiments, the facility receives an indication of a different cryptocurrency wallet than the cryptocurrency wallet used to pay the entry fee, such as via user input.

At act 904, the facility causes the generation of a meta-transaction transferring the indicated portion of rewards to the indicated cryptocurrency wallet. The portion of the rewards may include rewards earned by the competitor from multiple competitions. A meta-transaction is a transaction which is subsidized such that the participants of the transaction are not required to pay fees to execute the transaction. In some embodiments, the facility uses data regarding the competition, the smart contract, and the indicated cryptocurrency wallet to cause the generation of the meta-transaction. In some embodiments, the facility causes the generation of a meta-transaction to collect one or more entry fees from a competitor.

At act 905, the facility executes the meta-transaction. After act 905, the process ends.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collectively having contents configured to cause a computing device to perform a method for blockchain distribution of competition rewards, the method comprising:
receiving an indication of a competition, the indication of the competition including one or more rules for the competition;
applying a smart contract to the competition that implements the rules included in the indication of the competition;
receiving an indication of one or more competitors who wish to participate in the competition;
for each of the one or more competitors, facilitate the creation of one or more cryptocurrency wallets; and
for each of the indicated competitors:
collecting an entry fee from at least one cryptocurrency wallet associated with the competitor; and
automatically applying the at least one cryptocurrency wallet to the smart contract such that the competitor is a party associated with the smart contract and the competition.

2. The one or more instances of computer-readable media of claim 1, wherein the method further comprises:
generating a first meta-transaction to collect an entry fee from at least one competitor of the portion of the one or more competitors;
receiving an indication that at least one competitor of the portion of the one or more competitors has earned a reward from participating in the competition; and
generating a second meta-transaction to distribute the reward to the at least one competitor.

3. The one or more instances of computer-readable media of claim 1, wherein the method further comprises:
identifying an instance of a game associated with the competition based on the indication of the competition;
receiving an indication of the results of the instance of the game; and
identifying at least one competitor of the portion of the one or more competitors based on the received indication of the results of the instance of the game.

4. The one or more instances of computer-readable media of claim 3, wherein the indication of the results of the instance of the game are received by using an oracle configured to track the results of the game based on the indication of the instance of the game.

5. The one or more instances of computer-readable media of claim 3, wherein the method further comprises:
generating one or more escrow pools for at least one competitor of the portion of the one or more competitors based on the received indication of the results of the instance of the game.

6. The one or more instances of computer-readable media of claim 1, wherein the method further comprises:
receiving an indication of one or more layer two blockchain networks;
applying the smart contract based on the indication of the competition and the indication of one or more layer two blockchain networks.

7. The one or more instances of computer-readable media of claim 6, wherein the smart contract is compatible with a plurality of blockchain networks.

8. The one or more instances of computer-readable media of claim 1, wherein applying the smart contract further comprises:
applying a plurality of smart contracts to the competition, wherein:
at least one smart contract of the plurality of smart contracts is used to manage the competition;
at least one smart contract of the plurality of smart contracts is used to manage contributions to a reward pool for the competition;
at least one smart contract of the plurality of smart contracts is used to validate the winners of the competition; and
at least one smart contract of the plurality of smart contracts is used to facilitate the payment of gas fees for cryptocurrency transactions created for the competition.

9. One or more storage devices collectively storing a blockchain reward distribution data structure, the data structure comprising:
information specifying a competition, the information specifying the competition including one or more rules for the competition; and
information specifying one or more competitors who wish to participate in the competition,
such that the information specifying the competition is usable to apply a smart contract to the competition that implements the rules for the competition,
and such that the information specifying one or more competitors is usable to generate one or more cryptocurrency wallets for each of the specified competitors,
and such that the information specifying the competitors is usable to collect an entry fee from a respective cryptocurrency wallet associated with each of the specified competitors and to cause each specified competitor to be a party associated with the smart contract and the competition.

10. The one or more storage devices of claim 9, wherein the data structure further comprises:
information specifying an instance of a game associated with the competition, the information specifying the instance of the game including information specifying the result of the game.

11. The one or more storage devices of claim 10, wherein the information specifying the instance of the game further comprises:
information specifying an oracle which has access to the results of the game,
such that the information specifying the oracle is usable to receive the information specifying the results of the game.

12. The one or more storage devices of claim 10, wherein the data structure further comprises:
information specifying at least one escrow pool for at least one competitor of the portion of the one or more competitors, the information specifying at least one escrow pool including information specifying one or more rewards earned by the at least one competitor based on the result of the game.

13. The one or more storage devices of claim 9, wherein the data structure further comprises:
information specifying at least one group of competitors, the group of competitors including a plurality of competitors included in the portion of the one or more competitors,
such that, each competitor included in the group of competitors is a party to the smart contract.

14. The one or more storage devices of claim 9, wherein the data structure further comprises:
information specifying at least one layer two blockchain network,
such that the information specifying at least one layer two blockchain network is usable with the information specifying the competition to apply the smart contract to the competition.

15. The one or more storage devices of claim 9, wherein the data structure further comprises:
information specifying a plurality of smart contracts to the competition, wherein:
at least one smart contract of the plurality of smart contracts is used to manage the competition;
at least one smart contract of the plurality of smart contracts is used to manage contributions to a reward pool for the competition;
at least one smart contract of the plurality of smart contracts is used to validate the winners of the competition; and
at least one smart contract of the plurality of smart contracts is used to facilitate the payment of gas fees for cryptocurrency transactions created for the competition,
such that each smart contract of the plurality of smart contracts is able to be applied to the competition.

16. A system for blockchain distribution of competition rewards, the system comprising:
a computing device configured to:
receive an indication of a competition, the indication of the competition including one or more rules for the competition;
apply a smart contract to the competition that implements the rules included in the indication of the competition;
receive an indication of one or more competitors who wish to participate in the competition;
for each of the one or more competitors facilitates the creation of one or more cryptocurrency wallets; and
for each of the indicated competitors:
collect an entry fee from at least one cryptocurrency wallet associated with the competitor; and
automatically apply the at least one cryptocurrency wallet to the generated smart contract such that the competitor is a party associated with the smart contract and the competition.

17. The system of claim 16, wherein the computing device is further configured to:
generate a first meta-transaction to collect an entry fee from at least one competitor of the portion of the one or more competitors;
receive an indication that at least one competitor of the portion of the one or more competitors has earned a reward from participating in the competition; and
generate a second meta-transaction to distribute the reward to the at least one competitor.

18. The system of claim 16, wherein the computing device is further configured to:
identify an instance of a game associated with the competition based on the indication of the competition;
receive an indication of the results of the instance of the game; and
identify at least one competitor of the portion of the one or more competitors based on the received indication of the results of the instance of the game.

19. The system of claim 18, wherein the indication of the results of the instance of the game are received by using an oracle configured to track the results of the game based on the indication of the instance of the game.

20. The system of claim 18, wherein the computing device is further configured to:
generate one or more escrow pools for at least one competitor of the portion of the one or more competitors based on the received indication of the results of the instance of the game.

21. The system of claim 16, wherein the computing device is further configured to:
receive an indication of one or more layer two blockchain networks;
apply the smart contract based on the indication of the competition and the indication of one or more layer two blockchain networks.

22. The system of claim 21, wherein the smart contract is compatible with a plurality of blockchain networks.

23. The system of claim 16, wherein the computing device is further configured to:
apply a plurality of smart contracts to the competition, wherein:
at least one smart contract of the plurality of smart contracts is used to manage the competition;
at least one smart contract of the plurality of smart contracts is used to manage contributions to a reward pool for the competition;
at least one smart contract of the plurality of smart contracts is used to validate the winners of the competition; and
at least one smart contract of the plurality of smart contracts is used to facilitate the payment of gas fees for cryptocurrency transactions created for the competition.
